(19) United States
(12) Patent Application Publication
(10) Pub. No.: US 2021/0170228 A1
(43) Pub. Date: Jun. 10, 2021

(54) INFORMATION PROCESSING APPARATUS, INFORMATION PROCESSING METHOD AND PROGRAM

(71) Applicant: NIPPON TELEGRAPH AND TELEPHONE CORPORATION, Tokyo (JP)

(72) Inventor: Rika MOCHIZUKI, Musashino-shi, Tokyo (JP)

(21) Appl. No.: 17/270,168

(22) PCT Filed: Sep. 6, 2019
(86) PCT No.: PCT/IB2019/057518

§ 371 Date: Feb. 22, 2021

(30) Foreign Application Priority Data
Sep. 3, 2018 (JP) 2018-164651

(51) Int. Cl. A63B 24/00; G06F 16/901; G06F 16/908

(52) U.S. Cl. CPC A63B 24/0006; G06F 16/901; A63B 2024/0071; A63B 24/0062; A63B 2024/0012; G06F 16/908

(57) ABSTRACT

An information processing apparatus includes: a first storage unit that stores, for each of a plurality of first events, data including quantitative information related to the first event and data including subjective information related to the first event so as to be associated with each other; and a calculation unit that calculates, for each of combinations of the first events, an index value indicating similarity between the respective first events on the basis of the respective data of the respective first events related to the combination.

### TECHNICAL FIELD

The present invention relates to an information processing apparatus, an information processing method, and a program.

### BACKGROUND ART

If an event can be sensuously conveyed to a person making an effort to master the certain event (for example, a specific technique in a certain sport, a method for performing an instrument, or the like), a person unknown to the event, or the like, the mastering, understanding, or the like of the event can be effectively assisted.

In the related art, there has been employed a method in which the action of a performer and the target action are overlapped with each other to get close to a target action and promote an improvement (for example, NPL 1).

### CITATION LIST

### Non Patent Literature

[NPL 1] Yuki Nakamura, Koshiro Yanagi, Junki Nakagawa, Wen Wen, Hiroshi Yamakawa, Atsushi Yamashita, and Hajime Asama (2015), “Tyouzyou Eizou wo motiita Dousa Gakusyû Sien Sisutemu ni okeru Eizou Teizi Siten no Zidou Kettei (Automatic Determination of Video Presentation View in Action Learning Support System Using Overlapped Video)”, Conference Paper of The 3rd Domestic Event of Society of Serviceology, pp. 236-240, Kanazawa, April 2015 (peer reviewed oral presentation)

### SUMMARY OF THE INVENTION

### Technical Problem

On the other hand, the inventor of the present application held that it is possible to sensuously convey the event of a certain action or the like if the event of the certain action or the like can be compared to another event. However, an effective mechanism to express a certain event by analogy with another event has not been taken into consideration in the related art.

The present invention has been made in view of the above point and has an object of providing a mechanism that makes it possible to compare a certain event to another event.

### Means for Solving the Problem

In order to solve the above problem, an information processing apparatus includes: a first storage unit that stores, for each of a plurality of first events, data including quantitative information related to the first event and data including subjective information related to the first event so as to be associated with each other; and a calculation unit that calculates, for each of combinations of the first events, an index value indicating similarity between the respective first events on the basis of the respective data of the respective first events related to the combination.

### Effects of the Invention

A mechanism that makes it possible to compare a certain event to another event can be provided.

### BRIEF DESCRIPTION OF DRAWINGS

FIG. 1 is a diagram showing a configuration example of a system in an embodiment of the present invention.

FIG. 2 is a diagram showing a hardware configuration example of an understanding support apparatus 10 in the embodiment of the present invention.

FIG. 3 is a diagram showing a function configuration example of the understanding support apparatus 10 in the embodiment of the present invention.

FIG. 4 is a flowchart for describing an example of the processing steps of preliminary processing.

FIG. 5 is a diagram showing a configuration example of a category table T1.

FIG. 6 is a diagram showing a configuration example of a quantitative data table T2.

FIG. 7 is a diagram showing a configuration example of a subjective data table T3.

FIG. 8 is a diagram showing a configuration example of a similarity reinforcement element table T4.

FIG. 9 is a diagram showing an example of an input screen for inputting quantitative data, subjective data, and similarity reinforcement element data.

FIG. 10 is a diagram showing a configuration example of a similarity DB 122.

FIG. 11 is a diagram for describing items having a stronger correlation with the subjective data among the items of the quantitative data.

FIG. 12 is a flowchart for describing an example of the processing steps of processing to present a resemble expression.

FIG. 13 is a diagram showing a configuration example of a known information table T5.

FIG. 14 is a diagram showing a configuration example of a quantitative data table T2 corresponding to events belonging to a category “route”.

FIG. 15 is a diagram showing a configuration example of a subjective data table T3 corresponding to the events belonging to the category “route”.

FIG. 16 is a diagram showing a configuration example of a similarity reinforcement element table T4 corresponding to the events belonging to the category “route”.

FIG. 17 is a diagram showing a configuration example of a quantitative data table T2 corresponding to events belonging to a category “spicy food”.

FIG. 18 is a diagram showing a configuration example of a subjective data table T3 corresponding to the events belonging to the category “spicy food”.

FIG. 19 is a diagram showing a configuration example of a similarity reinforcement element table T4 corresponding to the events belonging to the category “spicy food”.

### DESCRIPTION OF EMBODIMENTS

### First Embodiment

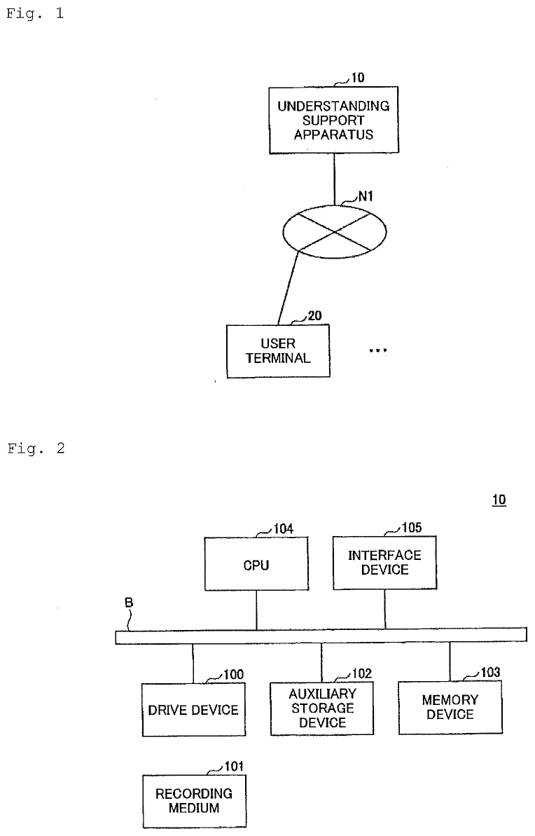

Hereinafter, an embodiment of the present invention will be described on the basis of the drawings. FIG. 1 is a diagram showing a configuration example of a system in the embodiment of the present invention. In FIG. 1, an understanding support apparatus 10 is connected to one or more user terminals 20 via a network N1 such as the Internet. The user terminals 20 may be connected to the network N1 via a radio channel or the like.

The understanding support apparatus 10 includes, for example, one or more computers that present an expression compared to an event (hereinafter called a “known event”) known to a user about an event that the user wants to know, an event that the user wants to master, or the like (hereinafter called as a “target event”) to the user to support user's sensuous understanding about the target event. For example, a case in which a user practicing a technique called a single stroke in drumming inputs the event of the single stroke in drumming as a target event is assumed. In this case, if swinging a badminton racket is an event known to the user and the swinging of a badminton racket is an action similar to the action of the single stroke in drumming, the understanding support apparatus 10 outputs, for example, a resemble expression such as “swing a badminton racket”.

The user terminals 20 are terminals such as smart phones, tablets, PCs (Personal Computers), and smart speakers owned by users to input information indicating (specifying) target events and output known events similar to the target events. In the present embodiment, respective events are specified by categories and names. In other words, the users input the categories and names of target events to the user terminals 20 as information indicating the target events. In the present embodiment, the categories are most significant concepts in an event classification structure. That is, events are roughly divided by the categories. The names are concepts that individually correspond to the events under the segmentalization of the categories. That is, the names are defined by grain sizes corresponding to the events. As described above, the present embodiment shows an example in which the events are classified by the two hierarchies of the categories and the names. However, a method for classifying the events is not limited to this. For example, the respective events may be defined by the three hierarchies of major classification, middle classification, and minor classification.

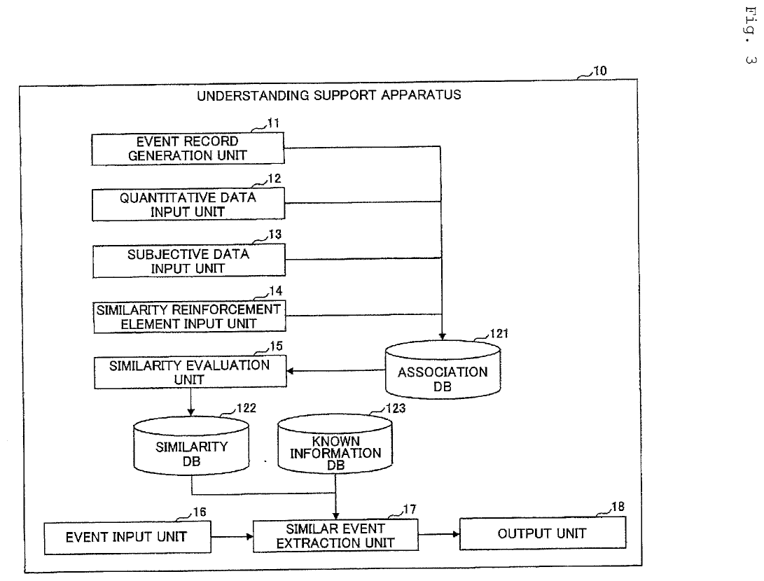

FIG. 2 is a diagram showing a hardware configuration example of the understanding support apparatus 10 in the embodiment of the present invention. The understanding support apparatus 10 of FIG. 2 has a drive device 100, an auxiliary storage device 102, a memory device 103, a CPU 104, an interface device 105, and the like, all of which are connected to each other via a bus B.

A program that realizes processing in the understanding support apparatus 10 is presented by a recording medium 101 such as a CD-ROM. When the recording medium 101 storing the program is set in the drive device 100, the program is installed in the auxiliary storage device 102 via the drive device 100 from the recording medium 101. However, the program is not necessarily required to be installed from the recording medium 101 and may be downloaded from other computers via a network. The auxiliary storage device 102 stores necessary files, data, or the like, besides the installed program.

The memory device 103 reads the program from the auxiliary storage device 102 and stores the same when receiving an instruction to activate the program. The CPU 104 performs functions related to the understanding support apparatus 10 according to the program stored in the memory device 103. The interface device 105 is used as an interface for establishing connection with a network.

FIG. 3 is a diagram showing a function configuration example of the understanding support apparatus 10 in the embodiment of the present invention. In FIG. 3, the understanding support apparatus 10 has an event record generation unit 11, a quantitative data input unit 12, subjective data input unit 13, a similarity reinforcement element input unit 14, a similarity evaluation unit 15, an event input unit 16, a similar event extraction unit 17, an output unit 18, and the like. The respective units are realized by processing that one or more programs installed in the understanding support apparatus 10 cause the CPU 104 to perform. Further, the understanding support apparatus 10 uses databases (storage units) such as an association DB 121, a similarity DB 122, and a known information DB 123. The realization of the respective databases is made possible by, for example, the auxiliary storage device 102, a storage device connectable to the understanding support apparatus 10 via a network, or the like.

The event record generation unit 11 registers the categories and names of respective events selectable by users in the association DB 121 according to, for example, an operation by a service provider.

The quantitative data input unit 12 inputs quantitative data related to an event for each of events (for each of categories and names) of which the categories and the names have been registered in the association DB 121, and registers the quantitative data in the association DB 121 so as to be associated with the category and the name of the event. In the present embodiment, the quantitative data refers to, for example, data including quantitative information such as a wrist angle and an arm angle in a certain action and a hot taste value acquired by a taste sensor about certain food that are objectively observable or measurable about an event. The input quantitative data preferably includes an ideal value for an event (a professional action for an action, an everyone's average for taste, or the like) as much as possible. In this regard, as for subjective data and similarity reinforcement element data that will be described later, an everyone's average, presence and absence, or the like (for example, a non-processional's average about a sense of fatigue or a typical place to have hotpot (spicy food)) rather than a professional's value is preferable.

The subjective data input unit 13 inputs subjective data related to an event for each of events (for each of categories and names) of which the categories and the names have been registered in the association DB 121, and registers the subjective data in the association DB 121 so as to be associated with the category and the name of the event. In the present embodiment, the subjective data refers to, for example, data including subjective information such as a sense of fatigue in a certain action and a sticky feeling in a mouth when eating food that are impressions on a person actually experiencing an event or the like.

The similarity reinforcement element input unit 14 inputs similarity reinforcement element data related to an event for each of events (for each of categories and names) of which the categories and the names have been registered in the association DB 121, and registers the similarity reinforcement element data in the association DB 121 so as to be associated with the category and the name of the event. In the present embodiment, in the case of an event related to an action, the similarity reinforcement element data refers to, for example, the characteristics of a tool (for example, the shape of a badminton racket or the like) used in an action, action duration (as to whether the action is instantly finished or repeatedly performed for a few minutes like fanning oneself), or the like. In the case of an event related to food, the similarity reinforcement element data refers to data including information such as the social status of food as to whether the food is something with a special taste that has an influence on determining the similarity between events when the information matches each other. Note that the information included in the similarity reinforcement element data may only be information other than information included in quantitative data or information included in subjective data, the information having an influence on determining the similarity between events when the information matches each other. The information included in the similarity reinforcement element data is not limited to prescribed information.

As is clear from the above, the association DB 121 stores quantitative data, subjective data, and similarity reinforcement element data related to an event so as to be associated with each other for each of events (for each of categories and names).

Using the quantitative data, the subjective data, and the similarity reinforcement element data of respective events related to a combination as input for each of combinations of events (combinations of two events) of which the categories and the names have been registered in the association DB 121, the similarity evaluation unit 15 calculates an index value (hereinafter called “similarity”) indicating the similarity between the respective events on the basis of the quantitative data, the subjective data, and the similarity reinforcement element data of the respective events related to a combination for each of combinations of the events (combinations of two events) of which the categories and the names have been registered in the association DB 121, and registers the calculated similarity in the similarity DB 122 so as to be associated with the combination. Accordingly, the similarity DB 122 stores, for each of combinations, similarity calculated by the similarity evaluation unit 15 for each of combinations of events. Note that the similarity reinforcement element data is not necessary for calculating similarity. That is, a mode in which the similarity reinforcement element data is not used may be employed.

The event input unit 16 receives (the input of) the category and name of an event (target event) for which the degree of sensation is needed to be presented by analogy from the user terminal 20 of a certain user, and outputs the received category and name to the similar event extraction unit 17.

Using the category and name of a target event from the event input unit 16 as input, the similar event extraction unit 17 extracts a part or all of events related to combinations with the target event as similar events corresponding to the target event on the basis of similarity stored in the similarity DB 122 about the combinations with the input target event. At this time, the similarity extraction unit refers to information stored in the known information DB 123 and narrows down the events extracted as the similar events into events known to a user. That is, the known information DB 123 stores flag information indicating as to whether an event is known to each user for each of combinations of categories and the names (that is, for each of events). The definition of a known event may include not only the fact that a user knows the event as his/her knowledge but also the fact that the user has actually experienced the event. Further, the definition of a known event may be arbitrarily determined by a service provider. The similar event extraction unit 17 outputs the extracted similar events.

The output unit 18 uses similar events extracted by the similar event extraction unit 17 as input and outputs the received similar events as the output of the apparatus.

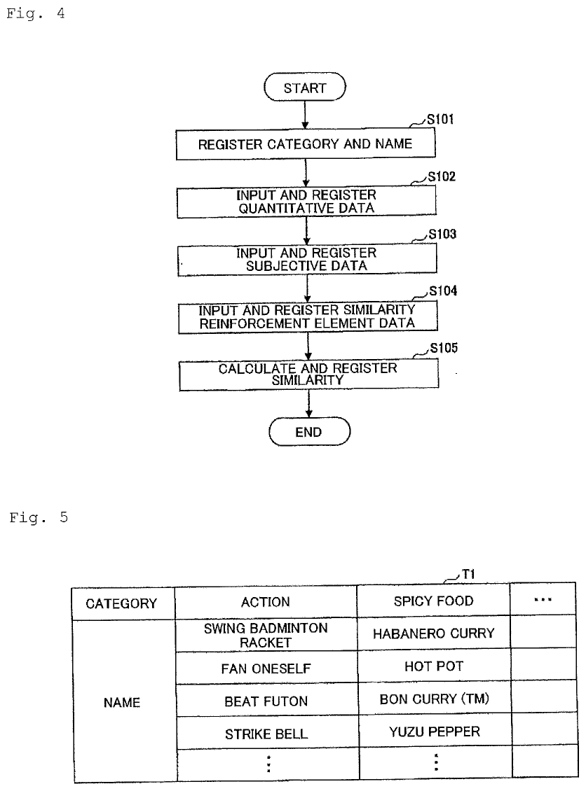

Hereinafter, processing steps performed by the understanding support apparatus 10 will be described. FIG. 4 is a flowchart for describing an example of the processing steps of preliminary processing.

In step S101, the event record generation unit 11 registers the category and name of each of a plurality of events selectable by a user in a category table T1 of the association DB 121 according to, for example, an operation by a service provider.

FIG. 5 is a diagram showing a configuration example of the category table T1. In FIG. 5, the category table T1 is a table in which a column is allocated for each of categories and the lists of names belonging to the respective categories are stored in a row direction. Accordingly, in step S101, the respective categories are registered in the column direction of the category table T1, and a list of names for each of the categories is registered in the row direction of the respective categories. Note that the categories and the lists of names belonging to the categories may be cited from, for example, dictionaries, documents, or the like. Specifically, the service provider or the like may cite the lists of names from dictionaries, documents, or the like and generate the category table T1 in advance. Further, using the electronic data of dictionaries or documents, differences may be automatically cited at data update to register the lists of names as the items of the names.

Subsequently, the quantitative data input unit 12 uses quantitative data related to an event as input for each of events (for each of the categories and the names) registered in the category table T1, and registers the quantitative data in a quantitative data table T2 of the association DB 121 so as to be associated with the category and the name of the event (S102). Note that the quantitative data may be manually input by the service provider or the like or may be automatically acquired by sensors or the like.

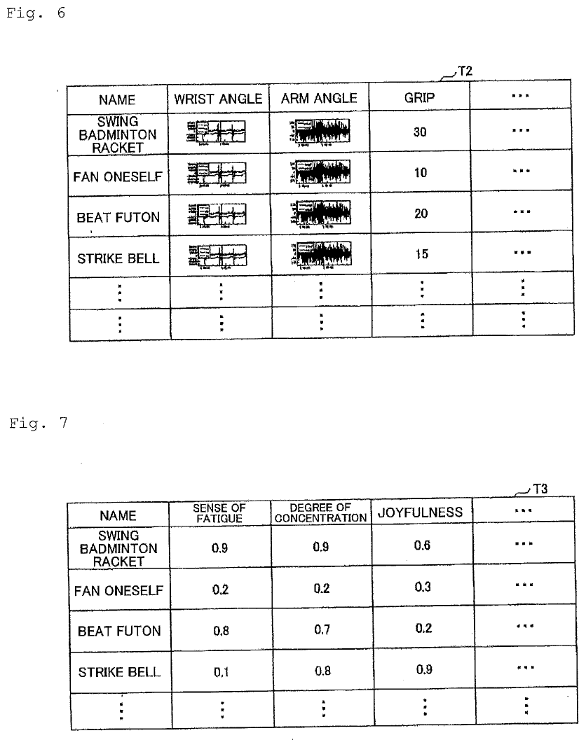

FIG. 6 is a diagram showing a configuration example of the quantitative data table T2. The quantitative data table T2 of FIG. 6 is a quantitative data table T2 corresponding to a category “action”. That is, the quantitative data table T2 is generated for each of the categories. This is because the configuration of quantitative data (the items (types) of the quantitative data, the number of the items, or the like) may be different for each of the categories. In this regard, the same applies to subjective data and similarity reinforcement element data.

In FIG. 6, the quantitative data table T2 is configured such that each quantitative data related to an event can be registered as one item for each of the names (that is, for each of the events) registered in the category table T1 (FIG. 5) about the category “action”. FIG. 6 shows an example in which a “wrist angle”, an “arm angle”, a “grip”, and the like are items constituting the quantitative data about the category “action”. In the present embodiment, one or more items are set with respect to one category. FIG. 6 shows an example in which time-series waveform data measured by sensors is used as the quantitative data as for the “wrist angle” and the “arm angle”. That is, the waveforms of the items of the “wrist angle” and the “arm angle” are graphs in which the horizontal axis shows a time and the vertical axis shows a wrist angle or an arm angle. Note that the respective items of the quantitative data of the respective categories may only be set by, for example, the service provider or the like before the quantitative data is input.

Subsequently, the subjective data input unit 13 uses subjective data related to an event as input for each of the events (for each of the categories and the names) registered in the category table T1, and registers the subjective data in a subjective data table T3 of the association DB 121 so as to be associated with the category and the name of the event (S103). Note that the subjective data may be manually input by the service provider or the like or may be automatically acquired by sensors or the like.

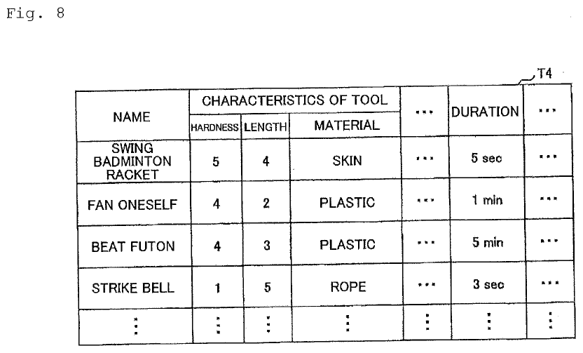

FIG. 7 is a diagram showing a configuration example of the subjective data table T3. The subjective data table T3 of FIG. 7 is a subjective data table T3 corresponding to the category “action”. That is, the subjective data table T3 is also generated for each of the categories. This is because the configuration of subjective data may be different for each of the categories.

In FIG. 7, the subjective data table T3 is configured such that each subjective data related to an event can be registered as one item for each of the names (that is, for each of the events) registered in the category table T1 (FIG. 5) with respect to the category “action”. FIG. 7 shows an example in which a “sense of fatigue”, the “degree of concentration”, “joyfulness”, and the like are items constituting the subjective data about the category “action”. In the present embodiment, one or more items are set with respect to one category as for the subjective data. FIG. 7 shows an example in which the values of the respective items of the subjective data are evaluated by numeric values of 0.0 to 1.0. Note that the items of the subjective data of the respective categories may only be set by, for example, the service provider or the like before the subjective data is input.

Subsequently, the similarity reinforcement element input unit 14 uses similarity reinforcement element data related to an event as input for each of the events (for each of the categories and the names) registered in the category table T1, and registers the similarity reinforcement element data in a similarity reinforcement element table T4 of the association DB 121 so as to be associated with the category and the name of the event (S104). Note that the similarity reinforcement element data may be manually input by the service provider or the like or may be automatically acquired by sensors or the like. However, events to which the similarity reinforcement element data is not input may exist. That is, similarity reinforcement element data of 0 or more may only be input to the respective events.

FIG. 8 is a diagram showing a configuration example of the similarity reinforcement element table T4. The similarity reinforcement element table T4 of FIG. 8 is a similarity reinforcement element table T4 corresponding to the category “action”. That is, the similarity reinforcement element table T4 is also generated for each of the categories. This is because the configuration of similarity reinforcement element data may be different for each of the categories.

In FIG. 8, the similarity reinforcement element table T4 is configured such that each similarity reinforcement element data related to an event can be registered as one item for each of the names (that is, for each of the events) registered in the category table T1 (FIG. 5) with respect to the category “action”. FIG. 8 shows an example in which “characteristics of a tool”, “duration”, and the like are items constituting the similarity reinforcement element data about the category “action”. The “characteristics of a tool” refer to the characteristics of a tool used for an action and constituted by the three elements of “hardness”, “length”, and “material” in the example of FIG. 8. The “hardness” refers to the hardness of a tool. The “length” refers to the length of a tool. The “material” refers to the material of a portion with which the hand of a user comes in contact. The “duration” refers to the duration of an action. The definition of the duration may only be appropriately set for each of the names (that is, for each of the events). For example, as for “swing a badminton racket”, a single swinging time or a repetitive swinging time for a prescribed number of times may be set.

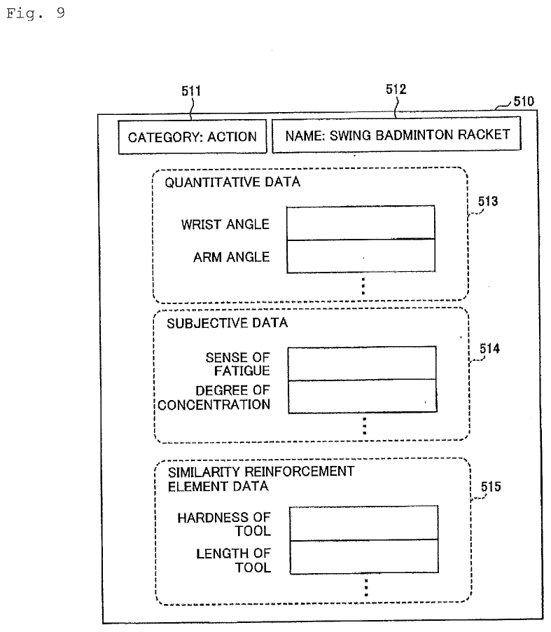

Note that when the quantitative data, the subjective data, and the similarity reinforcement element data are manually input by the service provider, the information may be input via, for example, a screen shown in FIG. 9.

FIG. 9 is a diagram showing an example of an input screen for inputting the quantitative data, the subjective data, and the similarity reinforcement element data. In FIG. 9, an input screen 510 includes a category selection menu 511, a name selection menu 512, a quantitative data input region 513, a subjective data input region 514, a similarity reinforcement element data input region 515, and the like.

The category selection menu 511 is a pull-down menu in which the categories registered in the column direction of the category table T1 (FIG. 5) are used as alternatives. FIG. 9 shows a state in which the “action” has been selected.

The name selection menu 512 is a pull-down menu in which the names registered in the row direction of the category table T1 (FIG. 5) are used as alternatives with respect to a category selected in the category selection menu 511. FIG. 9 shows a state in which “swing a badminton racket” among the names belonging to the category “action” has been selected.

The quantitative data input region 513 is a region for receiving the input of the values of the respective items of the quantitative data with respect to the “action” that has been selected in the category selection menu 511 and the event related to “swing a badminton racket” that has been selected in the name selection menu 512. In the present embodiment, the items of the quantitative data are set for each of the categories. Therefore, FIG. 9 shows a state in which the items of the quantitative data corresponding to the category “action” have been displayed. The items of the quantitative data corresponding to the category “action” are identifiable on the basis of the quantitative data table T2.

The subjective data input region 514 is a region for receiving the input of the values of the respective items of the subjective data with respect to the “action” that has been selected in the category selection menu 511 and the event related to “swing a badminton racket” that has been selected in the name selection menu 512. In the present embodiment, the items of the subjective data are set for each of the categories. Therefore, FIG. 9 shows a state in which the items of the subjective data corresponding to the category “action” have been displayed. The items of the subjective data corresponding to the category “action” are identifiable on the basis of the subjective data table T3.

The similarity reinforcement element data input region 515 is a region for receiving the input of the values of the respective items of the similarity reinforcement element data with respect to the “action” that has been selected in the category selection menu 511 and the event related to “swing a badminton racket” that has been selected in the name selection menu 512. In the present embodiment, the items of the similarity reinforcement element data are set for each of the categories. Therefore, FIG. 9 shows a state in which the items of the similarity reinforcement element data corresponding to the category “action” have been displayed. The items of the similarity reinforcement element data corresponding to the category “action” are identifiable on the basis of the similarity reinforcement element table T4.

Note that the configuration of the items of the quantitative data, the configuration of the items of the subjective data, and the configuration of the items of the similarity reinforcement element data do not necessarily completely match each other about all the names (events) belonging to the same category. Accordingly, data may not be input (or null may be input) to a part of the items of the quantitative data, the subjective data, and the similarity reinforcement element data depending on the names (events).

Note that in the case of data such as waveform data like the subjective data (such as the “wrist angle” and the “arm angle”) shown in FIG. 6, reading of files storing information with which the shapes of waveforms are identifiable may be allowed.

Subsequently, the similarity evaluation unit 15 calculates the similarity between the events related to a combination for each of combinations with all the other events (that is, for each of combinations of two events) about the respective events registered in the category table T1 (FIG. 5), and registers the calculated similarity in the similarity DB 122 so as to be associated with the combination (S105).

FIG. 10 is a diagram showing a configuration example of the similarity DB 122. In FIG. 10, the respective events (combinations of the categories and the names) are arranged in a row direction and a column direction, and similarity calculated about a combination is stored for each of combinations of the events in the respective rows and the events in the respective columns in the similarity DB 122. Note that as for the similarity between the same events, “MAX” indicating the maximum value of the similarity is stored.

Note that the similarity may be calculated by, for example, a method with which it is possible to calculate the comprehensive similarity between a plurality of items such as cosine similarity. For example, similarity sim may be calculated on the basis of the following formula.

$$sim ( x , y ) = \frac{x \cdot y}{( \vert x \vert \cdot \vert y \vert )} \\ \vert x \vert = \sqrt{x \cdot x} = \sqrt{{\sum }_{i = 1}^{N} {x}_{l}^{2} + Λ} \\ \vert y \vert = \sqrt{y \cdot y} = \sqrt{{\sum }_{i = 1}^{N} {y}_{i}^{2} + Λ} \\ x \cdot y = {\sum }_{i = 1}^{N} {x}_{i} \times {y}_{i} + Λ \qquad [ Formula 1 ]$$

where
x: the arrangement of the values of items related to one event (hereinafter called an “event X”)
y: the arrangement of the values of items related to the other event (hereinafter called an “event Y”)
xᵢ: the value of the i-th item in x
yᵢ: the value of the i-th item in y
A: a constant for preventing the denominator from being 0 (for example, 1 or the like)
N: the number of common items between the items related to the event X and the items related to the event Y

### i: 1 to N

Note that the arrangement of the values of the items refers to the arrangement of the values of the respective items of the quantitative data, the values of the respective items of the subjective data, and the value of the respective items of the similarity reinforcement element data. Further, the alignment sequence of the items in the arrangement of parameters in x and the alignment sequence of the items in the arrangement of parameters in y are the same. For example, xᵢ and yᵢ are the values of the same item (for example, the “wrist angle” of the subjective data).

When xᵢ and yᵢ are waveform-like series data like the “wrist angle” and the “arm angle” of the subjective data of FIG. 6, the similarity evaluation unit 15 may substitute representative values such as peak values into xᵢ and yᵢ. Alternatively, the similarity evaluation unit 15 may calculate n parameters among parameters representing the characteristics of waveforms such as respective peak values, in-phase properties, variance, and averages of xᵢ and yᵢ, segmentalize (divides) each of xᵢ and yᵢ into n variables, and substitute the calculation results of the respective parameters into the respective variables. Alternatively, the similarity evaluation unit 15 may perform Fourier transform on the respective waveforms of xᵢ and yᵢ and substitute respective spectrum values into xᵢ and yᵢ. Alternatively, using numeric value calculation software such as MATLAB, the similarity evaluation unit 15 may calculate the cross correlation between the waveform of xᵢ and the waveform of yᵢ according to a function xcorr( ) or the like. In this case, instead of substituting xᵢ and yᵢ into formula 1, the similarity evaluation unit 15 may add the cross correlation calculated about xᵢ and yᵢ to the similarity calculated on the basis of formula 1 in relation to other items to calculate the final similarity between the event X and the event Y.

Further, when xᵢ and yᵢ are the values of non-digitized items like the “material” of the similarity reinforcement element data of FIG. 8, the similarity evaluation unit 15 may digitize xᵢ and yᵢ as 1 and 1, respectively, if xᵢ is equal to yᵢ and digitize xᵢ and yᵢ as 0 and 0, respectively, if xᵢ is not equal to yᵢ.

This is because the configuration of each of the quantitative data, the subjective data, and the similarity reinforcement element data is common within the range of the same category in the present embodiment. Accordingly, if the event X and the event Y are events in the same category, x and y are constituted by the arrangement of the same items in the present embodiment. However, when any one of the values of xᵢ and yᵢ is zero (null), calculation may not be performed on the i-th item.

On the other hand, if the event X and the event Y are events in different categories, x and y are not necessarily constituted by the arrangement of the same items. In this case, the similarity evaluation unit 15 may only extract common items between items related to the event X and items related to the event Y and set the arrangement of the values of the respective common items of the event X as x and the arrangement of the values of the respective common items of the event Y as y when the extracted common items are arranged in the same order. When there is no common item between the event X and the event Y, the similarity evaluation unit 15 may only set the similarity between the event X and the event Y at a minimum value (for example, 0).

Note that the similarity evaluation unit 15 may substitute the values of the respective items into xᵢ or yᵢ after relativizing (or normalizing) the same between 0 or more and 1 or less.

Further, all or a part of the common items between the event X and the event Y may be used to calculate the similarity. The items used to calculate the similarity may be selected in advance by the service provider. In this case, the service provider selects one or more items from the quantitative data and the subjective data and selects 0 or more items from the similarity reinforcement element data. For example, items on which the service provider wants to give importance may be selected as targets used to calculate the similarity. Further, when the event X and the event Y belong to the same category, only items to which values are input in an event having the smallest number items to which the values are input among events in the category may be used to calculate the similarity. Further, only the items to which the values are input with respect to all the events in the category may be used to calculate the similarity. Note that when the items used to calculate the similarity are limited to a part of the common items, flag information indicating that the part of the common items is an element to calculate the similarity may be provided by the service provider. Specifically, the flag information may be assigned to items selected as elements to calculate the similarity among the respective items of the quantitative data table T2 (FIG. 6), the subjective data table T3 (FIG. 7), and the similarity reinforcement element table T4 (FIG. 8). Note that as for the quantitative data and the subjective data, the flag information may be assigned only to one item or may be assigned to a plurality of items as information indicating the order of importance. As for the similarity reinforcement element data, the flag information may not be assigned to all the items or may be assigned to one or more items as information indicating the order of importance. In this case, the similarity evaluation unit 15 may put a weight on each of the items to calculate the similarity such that the items to which the flag information is assigned are given greater importance than the items to which the flag information is not assigned. For example, the similarity evaluation unit 15 may calculate the similarity using only the items to which the flag information is assigned. Further, when a weight is put on a plurality of items as information indicating the order of importance, the similarity evaluation unit 15 may put a greater weight on items to which importance is needed to be given to calculate the similarity.

Further, as for the subjective data, the similarity evaluation unit 15 may use only one or more items having a stronger correlation with the subjective data among the common items between the event X and the event Y to calculate the similarity. In this manner, impressions on persons about the similarity between the events can be more strongly taken into consideration. That is, this is because the persons possibly have different impressions even if actions themselves are somewhat similar to each other.

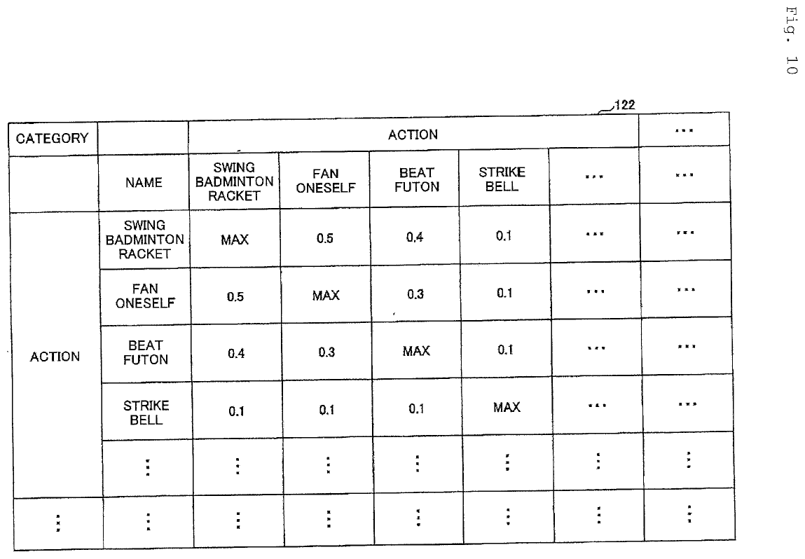

FIG. 11 is a diagram for describing items having a stronger correlation with the subjective data among the items of the quantitative data. FIG. 11 shows an example in which the subjective data of a plurality of persons including person A, person B, person C, and the like is collected and the correlations between the respective items of the quantitative data and the subjective data of the plurality of persons are calculated.

In the example of FIG. 11, it is shown that the correlations between the “wrist angle” among the items of the quantitative data of the event “swing a badminton racket” and the subjective data are as follows.

A correlation with a sense of fatigue: 0.9
A correlation with the degree of concentration: 0.2
A correlation with joyfulness: 0.3
Further, it is shown that the correlations between the “arm angle” among the items of the quantitative data of the event “swing a badminton racket” and the subjective data are as follows.
A correlation with a sense of fatigue: 0.7
A correlation with the degree of concentration: 0.2
A correlation with joyfulness: 0.3

In addition, FIG. 11 shows an example in which the correlations between the “grip” among the items of the quantitative data of the event “swing a badminton racket” and the subjective data are as follows.

A correlation with a sense of fatigue: 0.5
A correlation with the degree of concentration: 0.5
A correlation with joyfulness: 0.4

When a threshold for the correlations is 0.7 and the items of the threshold or more are selected, the “wrist angle” and the “arm angle” are regarded as elements for calculating the similarity and the “grip” is excluded from the elements for calculating the similarity in the example of FIG. 11.

Note that the similarity evaluation unit 15 may select items having a relatively higher correlation with the subjective data among the items of the quantitative data at the time of calculating the similarity. In this case, the number of the selected items may be set in advance by the service provider. Alternatively, for example, the service provider may select in advance one for more items having a relatively higher correlation with the subjective data, and flag information for discriminating the selected items may be assigned to the subjective data table T3. The calculation (weighting or the like) of the similarity when the flag information is assigned may be performed in the manner described above.

Further, as for the respective common items between the quantitative data, the subjective data, and the similarity reinforcement element data, the similarity evaluation unit 15 may perform weighting on the basis of the specificity of the respective common items to calculate the similarity. The weighting may be performed in the manner described above. Items having higher specificity refer to items including distinctive values (or characteristic values). For example, the similarity evaluation unit 15 calculates the specificity of the respective items according to the following steps (1) to (3).

(1) The similarity evaluation unit 15 calculates index values (hereinafter called the “degree of specificity”) obtained by digitizing distinctiveness (specificity) about the respective values of the respective items for each of the quantitative data table T2 (FIG. 6), the subjective data table T3 (FIG. 7), and the similarity reinforcement element table T4 (FIG. 8) in the same category. Taking the similarity reinforcement element table T4 of FIG. 8 as an example, the similarity evaluation unit 15 calculates the degree of specificity about the value of each of the items for each of the “hardness”, the “length”, the “material”, and the “duration”. For example, the similarity evaluation unit 15 calculates the degree of specificity for each of “skin”, “plastic”, “rope”, and the like about the “material”. The degree of specificity may only be a digitized one indicating to what degree the value is distinctive (characteristic) in the item. For example, the degree of specificity may be calculated by the absolute value of a difference from the average of the values of the item, the low frequency of appearance (for example, the inverse number of appearance frequency) in the item, or the like. Accordingly, in, for example, the “material”, the degree of specificity of the “skin” becomes high if the appearance frequency of the “skin” is low, and the degree of specificity of the “plastic” becomes low if the appearance frequency of the “plastic” is high.
(2) The similarity evaluation unit 15 specifies a maximum value for each of the items about the degree of specificity calculated for each of the values about the respective items.
(3) The similarity evaluation unit 15 compares the maximum values of the respective items with each other to determine the weighting of the respective items. For example, the similarity evaluation unit 15 selects some of the items as calculation elements for calculating the similarity. Specifically, items in which the maximum value of the degree of specificity is a threshold or more (for example, 0.8 or the like when the maximum value of the degree of specificity possibly taken in the respective items is normalized as 1 and the minimum value thereof is normalized as 0) may be selected as the calculation elements. Alternatively, top n items having the maximum value may be selected as the calculation elements. Note that when the degree of specificity is calculated by appearance frequency, the degree of specificity possibly taken is 0 if a value appears every time and is a ratio corresponding to the number of appearance times. For example, when the degree of specificity is calculated on the basis of the number of appearance times about the “rope” in the item of the “material of a tool” in T4 of FIG. 8, the degree of specificity is calculated by a formula such as “the degree of specificity=1−(the number of appearance times/the number of appearance times in a case in which the rope appears every time)” by which the degree of specificity becomes higher as the number of appearance times is smaller. Further, when the degree of specificity is calculated by a difference from an average, it is considered that the degree of specificity is 0 if the difference is 0, and that a limit value most separated from the average is 1. For example, when the degree of specificity is calculated by a difference from an average about the item “arm angle” in T2 of FIG. 6, the maximum value or the average of values recorded as “arm angles” is used. The degree of specificity is calculated by a formula by which the degree of specificity becomes 0 when the difference between an “arm angle” in the item concerned (for example, “swing a badminton racket”) and the average of “arm angles” in all the items is 0 and by which the degree of specificity becomes 1 when the “angle of an arm” movable by a human is a maximum angle and/or a minimum angle.

FIG. 12 is a flowchart for describing an example of the processing steps of processing to present a resemble expression.

In step S201, the event input unit 16 receives, from a user terminal 20 of a certain user (hereinafter called a “target user”), (the input of) the category and the name of an event (target event) such as a “single stroke in drumming” for which the degree of sensation is needed to be presented by analogy. The input of the category and the name to the user terminal 20 may be performed by, for example, the selection of the category from a pull-down menu for categories and the selection of the name from a pull-down menu for names on a prescribed screen. In this case, the user terminal 20 transmits character strings indicating the selected category and the name to the understanding support apparatus 10. Alternatively, the category and the name of the target event may be input to a prescribed screen displayed on the user terminal 20 as, for example, free-form character strings. In this case, the user terminal 20 transmits the input free-form character strings to the understanding support apparatus 10.

Alternatively, when the user terminal 20 is a smart speaker, the user terminal 20 may list and output the sound of categories and names as alternatives. In this case, the user may input the category and the name of a target event by speaking any category and any name among the listed categories and the names. Alternatively, instead of the listing of the sound of categories and names as alternatives, the user may speak the category and the name of a target event to the user terminal 20 in a free form. In any case, the user terminal 20 transmits input sound to the understanding support apparatus 10.

The event input unit 16 of the understanding support apparatus 10 receives character strings or sound input to the user terminal 20 in the manner described above from the user terminal 20. When receiving sound, the event input unit 16 performs sound recognition on the sound to convert the received sound into character strings. Hereinafter, received character strings or character strings converted from sound will be called “input character strings”.

Subsequently, the event input unit 16 analyzes the input character strings to specify the category (hereinafter called the “target category”) and the name (hereinafter called the “target name”) of the target event (S202). When the input character strings include a category and a name selected from alternatives, the event input unit 16 specifies the category and the name as the target category and the target name, respectively. When the input character strings are free-form character strings, the event input unit 16 specifies a category and a name matching the input character strings or a category and a name most similar to the input character strings as the target category and the target name, respectively. The similar category may be extracted by, for example, a method in which a name identification setting file is prepared in advance and “texture”, “softness”, “hardness” and the like are consolidated into a category “mouth feel” if they are input character strings. The same applies to the name.

Note that the event input unit 16 inputs the identification information of the target user (hereinafter called a “target user ID”), the target category, and the target name to the similar event extraction unit 17. The target user ID may be received from the user terminal 20 before step S201 or may be received from the user terminal 20 in step S201.

Subsequently, the similar event extraction unit 17 extracts an event known to the target user (hereinafter called a “known event”) from a known information table T5 corresponding to the target user ID among known information tables T5 registered for respective user IDs in the known information DB 123 (S203).

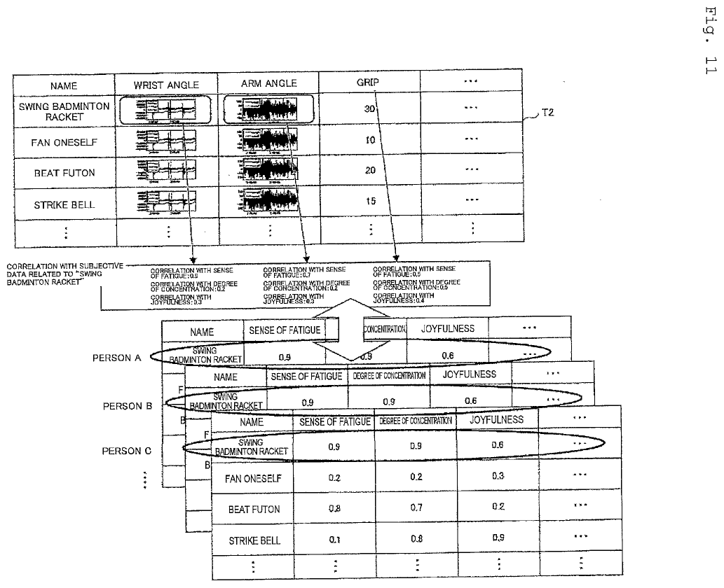

FIG. 13 is a diagram showing a configuration example of the known information table T5. The known information table T5 of FIG. 13 shows the known information table T5 of a target user.

In FIG. 13, the known information table T5 stores, for each of combinations of categories and names (that is, for each of events), a “known flag” that is flag information indicating as to whether the event concerned is known to the target user. As for the “known flag”, “1” indicates that the event is known to the target user, and “0” indicates that the event is unknown to the target user.

The registration of the “known flags” in the known information table T5 for the respective events may be manually performed in advance by the user himself/herself on the user terminal 20 or the like. Alternatively, the “known flags” may be automatically registered using user's logs such as estimating knowledge from user's retrieval logs. Alternatively, the known information table T5 of each user may not be registered in advance in the known information DB 123. For example, the known information table T5 may be stored in the user terminal 20. In this case, the user terminal 20 may upload the known information table T5 stored in the own terminal to the understanding support apparatus 10 at the arbitrary timing of each user (for example, at the timing of step S201 of FIG. 12) to register the known information table T5 in the known information DB 123.

In any case, in step S203, the similar event extraction unit 17 extracts combinations (that is, events) of a category and names of which the values of the “known flags” are 1, that is, a category and names which are known, as the category and the names of the events known to the target user.

Subsequently, the similar event extraction unit 17 acquires the similarity between the extracted respective known events and the target event from the similarity DB 122 (FIG. 10) (S204). Specifically, the similar event extraction unit 17 acquires similarity stored in the similarity DB 122 with respect to combinations of the category and the names of the known events and the target category and the target name.

Subsequently, the similar event extraction unit 17 extracts a part or all of the known events in the descending order of the acquired similarity (S205). For example, the similar event extraction unit 17 may extract n known events (up to the n-th known event) in the descending order of the similarity. Note that the similarity is an index of which the value increases as the similarity becomes higher in the present embodiment. If an index of which the value decreases as the similarity becomes higher is used as the similarity, n known information may only be extracted in the ascending order of the acquired similarity. n is an integer of 1 or more, may be set in advance, and may be designated at the time of inputting the target event by the target user. Alternatively, n may be fixed at 1. Alternatively, all the known events having the similarity of a threshold or more may be extracted. The similar event extraction unit 17 inputs the extracted known events (hereinafter called “similar events”) to the output unit 18.

Subsequently, the output unit 18 outputs the similar events input from the similar event extraction unit 17 (S206). In the present embodiment, the output unit 18 transmits information indicating the similar events to the user terminal 20. The information indicating the similar events may be expressed in an arbitrary fashion. For example, the output unit 18 may output the similarity between the target event and the respective similar events together with the category name and the names of the respective similar events. Alternatively, the output unit 18 may output a diagram in which the target event is arranged at the center and the category name and the names of the similar events may be radially arranged around the target event according to the similarity. Alternatively, the output unit 18 may output an image indicating the similar events. In this case, for example, an image indicating the events that are associated with the respective names (that is, the respective events) registered in the category table T1 (FIG. 5) and related to the names may be stored in advance in the association DB 121.

### Second Embodiment

Next, a second embodiment will be described. In the second embodiment, a point different from that of the above first embodiment will be described. Points that will not be particularly mentioned in the second embodiment may be the same as those of the first embodiment.

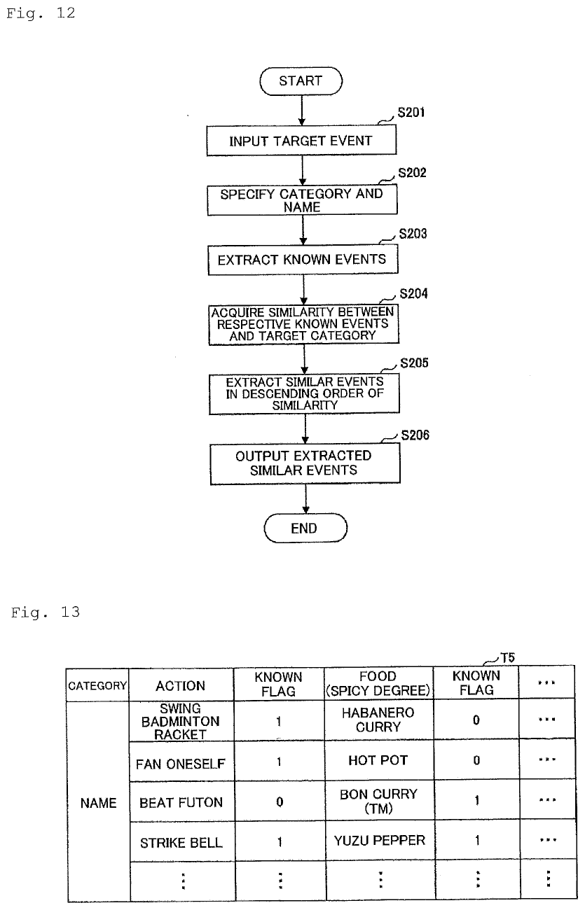

The above first embodiment mainly describes the events belonging to the category “action”. However, events applicable to the second embodiment are not limited to events related to the “action”. For example, events related to a route may be applied. In this manner, when a route is guided by guidance navigation application or the like, the degree of fatigue or the like under the route can be presented by analogy with a route known to a user. In this case, tables shown in FIGS. 14 to 16 are, for example, registered in the association DB 121, and the tables may be used.

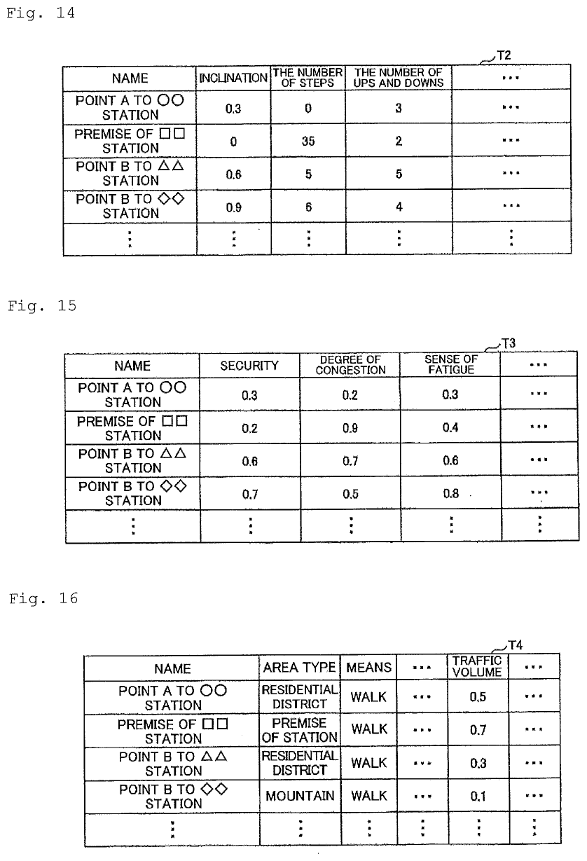

That is, FIG. 14 is a diagram showing a configuration example of a quantitative data table T2 corresponding to events belonging to a category “route”. Further, FIG. 15 is a diagram showing a configuration example of a subjective data table T3 corresponding to the events belonging to the category “route”. In addition, FIG. 16 is a diagram showing a configuration example of a similarity reinforcement element table T4 corresponding to the events belonging to the category “route”.

### Third Embodiment

Next, a third embodiment will be described. In the third embodiment, a point different from that of the above first or second embodiment will be described. Points that will not be particularly mentioned in the third embodiment may be the same as those of the first or second embodiment.

In the third embodiment, events related to spicy food may be applied. In this manner, the spicy degree of food unknown to a user can be presented by analogy with food that the user has ever eaten. In this case, tables shown in FIGS. 17 to 19 are, for example, registered in the association DB 121, and the tables may be used.

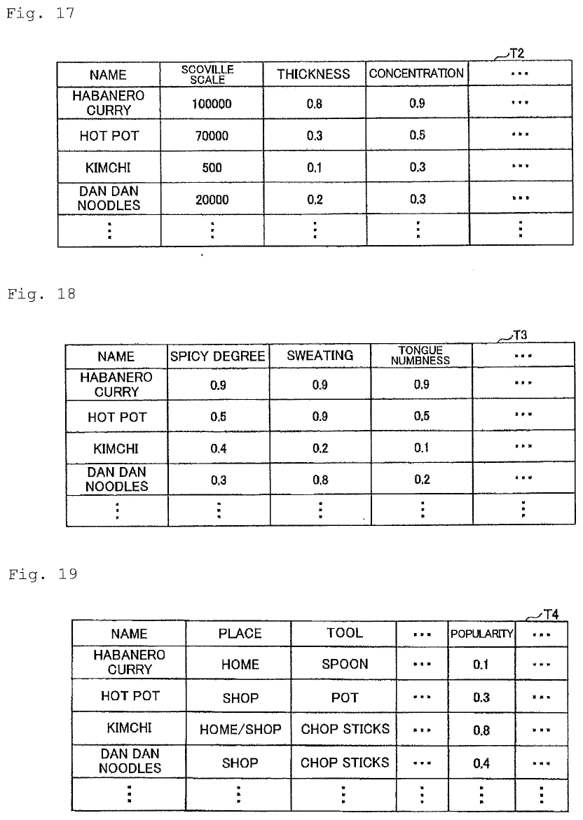

That is, FIG. 17 is a diagram showing a configuration example of a quantitative data table T2 corresponding to events belonging to a category “spicy food”. Further, FIG. 18 is a diagram showing a configuration example of a subjective data table T3 corresponding to the events belonging to the category “spicy food”. In addition, FIG. 19 is a diagram showing a configuration example of a similarity reinforcement element table T4 corresponding to the events belonging to the category “spicy food”.

As described above, the similarity between events is calculated on the basis of quantitative data and subjective data related to the respective events according to the present embodiment. When a certain event is compared to another event, the similarity can be used as a reference for selecting the other event. This is because the similar events are assumed to be suitable to be compared to each other. Accordingly, a mechanism that makes it possible to compare a certain event to another event can be presented according to the present embodiment.

Further, similarity is calculated using similarity reinforcement element data as well in the present embodiment. The accuracy of the similarity can be enhanced using the similarity reinforcement element data.

Further, when a certain event (target event) is input by a user, a similar event is output on the basis of the similarity between the similar event and the event in the present embodiment. Accordingly, the understanding of the target event by the user can be supported by a resemble expression using another event.

Further, an event known to a user is output as an event similar to a target event in the present embodiment. By presenting known similar experience and knowledge in a user's daily life as a similar event, the present embodiment can simply convey the degree of sensation of a target event. For example, in a case in which the degree of finger forces of an expert is conveyed to a beginner at the time of practicing a musical instrument or the like, a case in which the taste (spicy degree)/mouth feel (hardness degree) of unknown food is conveyed, a case in which the emergency of news related to the occurrence of an earthquake is conveyed to a foreigner visiting to Japan, or the like, the present embodiment can simply convey the degree of sensation (a sensuous knack such as a physical action, a criterion for likes and dislikes of food, the seriousness of an event, or the like).

Note that the understanding support apparatus 10 is an example of an information processing apparatus in the present embodiment. The association DB 121 is an example of a first storage unit. The similarity evaluation unit 15 is an example of a calculation unit. The similarity DB 122 is an example of a second storage unit. The event input unit 16 is an example of an input unit. The similar event extraction unit 17 is an example of an extraction unit. The known information DB 123 is an example of a third storage unit. An event of which the category name and the name have been registered in the category table T1 is an example of a first event. A target event is an example of a second event.

The embodiments of the present invention are described in detail above. However, the present invention is not limited to such specific embodiments and is deformable and modifiable in various ways within the spirit of the present invention described in claims.

### REFERENCE SIGNS LIST

10 Understanding support apparatus
11 Event record generation unit
12 Quantitative data input unit
13 Subjective data input unit
14 Similarity reinforcement element input unit
15 Similarity evaluation unit
16 Event input unit
17 Similar event extraction unit
18 Output unit
20 User terminal
100 Drive device
101 Recording medium
102 Auxiliary storage device
103 Memory device
104 CPU
105 Interface device
121 Association DB
122 Similarity DB
123 Known information DB
B Bus

1. An information processing apparatus comprising:
a computer including a memory and a processor coupled to the memory, the computer configured to function as:
a first storage unit that stores, for each of a plurality of first events, data including quantitative information related to the first event and data including subjective information related to the first event so as to be associated with each other; and
a calculation unit that calculates, for each of combinations of the first events, an index value indicating similarity between the respective first events on a basis of the respective data of the respective first events related to the combination.

2. The information processing apparatus according to claim 1, wherein the first storage unit further stores, for each of the plurality of first events, data including information other than the quantitative information or the subjective information, the data including information that has an influence on the similarity between the first events when the information matches each other between the first events, and the calculation unit further calculates, for each of the combinations of the first events, the index value on a basis of the data including the information that has an influence on the similarity between the respective first events related to the combination.

3. The information processing apparatus according to claim 1, wherein the calculation unit performs, for each of items of the respective data, weighting based on specificity of the item to calculate the index value.

4. The information processing apparatus according to claim 1, wherein the computer is further configured to function as:
a second storage unit that stores, for each of the combinations, the index value calculated for each of the combinations by the calculation unit;
an input unit that receives input of information indicating a second event from a user;
an extraction unit that extracts, on a basis of similarity stored in the second storage unit about combinations with the second event, a part or all of the first events related to the combinations with the second event; and
an output unit that outputs information indicating the first events extracted by the extraction unit.

5. The information processing apparatus according to claim 4, wherein the computer is further configured to function as:
a third storage unit that stores, for each of the first events, information indicating as to whether the first event is known to the user, wherein the extraction unit refers to the third storage unit and extracts, on a basis of the index values, a part or all of the combinations from the combinations with the second event and the combinations with the first events known to the user among the combinations of which the index values are stored in the second storage unit.

6. An information processing method performed by computer, comprising:
storing, for each of a plurality of first events, data including quantitative information related to the first event and data including subjective information related to the first event so as to be associated with each other in the first storage; and
calculating, for each of combinations of the first events, an index value indicating similarity between the respective first events on a basis of the respective data of the respective first events related to the combination.

7. A non-transitory computer readable medium having a program embedded therein for causing a computer to function:
a first storage unit that stores, for each of a plurality of first events, data including quantitative information related to the first event and data including subjective information related to the first event so as to be associated with each other; and
a calculation unit that calculates, for each of combinations of the first events, an index value indicating similarity between the respective first events on a basis of the respective data of the respective first events related to the combination.
